(19) United States
(12) Patent Application Publication
(10) Pub. No.: US 2015/0379495 A1
(43) Pub. Date: Dec. 31, 2015

(54) MONEY HANDLING SYSTEM, MONEY HANDLING APPARATUS, AND MONEY HANDLING METHOD

(71) Applicant: GLORY LTD., Himeji-shi, Hyogo (JP)

(72) Inventors: Keiju NAKAGAWA, Himeji-shi, Hyogo (JP); Kazuhiro DOI, Himeji-shi, Hyogo (JP); Minoru HIGASHIYAMA, Himeji-shi, Hyogo (JP)

(73) Assignee: GLORY LTD., Himeji-shi, Hyogo (JP)

(21) Appl. No.: 14/768,381

(22) PCT Filed: Feb. 26, 2013
(86) PCT No.: PCT/JP2013/054863

§ 371 Date: Aug. 17, 2015

(51) Int. Cl. G06Q 20/20

(52) U.S. Cl. CPC G06Q 20/20

(57) ABSTRACT

A money handling system that performs a process of settling a charge for a specific service includes a charge amount acquiring unit that acquires a charge amount corresponding to the change for the specific service; an amount calculating unit that calculates an amount of the money that has been taken in; and a tip amount identifying unit that identifies a tip amount for the specific service. A main control unit identifies the change amount so that the total of the charge amount acquired by the charge amount acquiring unit, the tip amount identified by the tip amount identifying unit, and the change amount of the money to be dispensed as the change becomes equal to the amount calculated by the amount calculating unit, and exerts control so that the money equivalent to the change amount is dispensed by the banknote dispensing unit and the coin dispensing unit.

### TECHNICAL FIELD

The present invention relates to a money handling system, a money handling apparatus, and a money handling method that perform a process of settling charge for a specific service and to a money handling apparatus and a money handling method that perform a process of depositing money including charges and tips paid for the specific service.

### BACKGROUND ART

Conventionally, money deposit and dispense handling systems that mechanically and automatically perform process of depositing and dispensing banknotes and coins are used at the counters of banking facilities and transport facilities or at checkout counters of supermarkets and the like. Such a money deposit and dispense handling system includes a banknote depositing and dispensing apparatus that performs a process of depositing and dispensing banknotes, a coin depositing and dispensing apparatus that performs a process of depositing and dispensing coins, and a cash register that performs registration of amounts such as sales price of commodities and causes the banknote depositing and dispensing apparatus and the coin depositing and dispensing apparatus to perform respective depositing and dispensing processes. Point-of-sale (POS) registers are the devices that perform the functions of such a cash register at the checkout counters of supermarkets and the like. Such a money deposit and dispense handling system has been disclosed in Japanese Patent No. 4128244, for example.

### SUMMARY OF INVENTION

The conventional money deposit and dispense handling system cannot be introduced to perform operations at locations other than the checkout counters of supermarkets, i.e., to perform operations for service businesses run in restaurants and bars, clubs, hotels, and the like, for example, where customers customarily leave a tip in addition to paying for the remuneration for the received service itself as a token of appreciation for the employees. The reason is that the conventional money deposit and dispense handling systems cannot handle the tips. More specifically, the conventional money deposit and dispense handling systems can dispense the difference between the money received from a customer and the total sales price of the commodities as a change; however, these systems have a drawback that if any tip is included in the money received from the customer, these systems cannot dispense a change after subtracting the tip amount from the difference. As explained above, when the conventional money deposit and dispense handling system is to be used to perform operations for service businesses run in restaurants and bars, clubs, hotels, and the like, it is necessary to consider the tips left by the customers if the process of depositing and dispensing banknotes and coins is to be performed mechanically and automatically.

The present invention has been made in consideration of the above discussion, and an object of the present invention is to provide a money handling system, a money handling apparatus, and a money handling method capable of mechanically and automatically performing the process of depositing and dispensing banknotes and coins while considering the tip received from the customers.

A money handling system of the present invention is a money handling system that performs a process of settling a charge for a specific service, including a charge amount acquiring unit that acquires a charge amount corresponding to the charge; an inlet unit for taking in money; an amount calculating unit that calculates an amount of the money taken in by the inlet unit; a money storage unit that stores therein the money of which the amount has been calculated by the amount calculating unit; a change dispensing unit that dispenses money equivalent to a change amount as a change from the money storage unit or a change money storage unit; a tip amount identifying unit that identifies a tip amount corresponding to a tip for the specific service; and a control unit that determines the change amount so that a total of the charge amount acquired by the charge amount acquiring unit, the tip amount identified by the tip amount identifying unit, and the change amount of money to be dispensed as the change by the change dispensing unit becomes equal to the amount calculated by the amount calculating unit, and exerts control so that money equivalent to the change amount is dispensed by the change dispensing unit.

In the money handling system of the present invention, the tip amount identifying unit may identify the tip amount based on a directly inputted tip amount.

Alternatively, the tip amount identifying unit may identify the tip amount based on an inputted tipping ratio corresponding to the charge amount acquired by the charge amount acquiring unit.

Alternatively, if a change amount to be dispensed as a change has been inputted, the tip amount identifying unit may identify the tip amount by subtracting a total amount of the charge amount acquired by the charge amount acquiring unit and the inputted change amount from the amount calculated by the amount calculating unit.

Alternatively, if an amount of money to be paid larger than the charge amount acquired by the charge amount acquiring unit has been inputted, the tip amount identifying unit may identify the tip amount by subtracting the charge amount acquired by the charge amount acquiring unit from the inputted amount to be paid.

The money handling system of the present invention may further include a communication unit that transmits the tip amount identified by the tip amount identifying unit to a higher-level apparatus.

The money handling system of the present invention may further include a tip recipient identifying unit that identifies a tip recipient who is to receive the tip; and a memory unit that stores therein the tip amount identified by the tip amount identifying unit and the tip recipient identified by the tip recipient identifying unit in a mutually associated manner.

In this case, the tip recipient identifying unit may include an ID information input unit that inputs ID information about a person in charge of a settlement process, and the memory unit may store therein the tip amount identified by the tip amount identifying unit and the ID information inputted by the ID information input unit in a mutually associated manner.

The money handling system of the present invention may further include a memory unit that stores therein information about the charge to be paid for the specific service and information about the tip therefor in a distinguishable manner with respect to an amount of money for which settlement a process is performed, and the control unit, if the tip amount identified by the tip amount identifying unit has been initially “0”, in one transaction, and when money as a change has been taken in by the inlet unit after money as a change has been dispensed by the change dispensing unit, may control the memory unit to store therein the amount of the money that has been taken in as the tip amount.

In this case, the tip amount identifying unit may identify that the tip amount has been initially “0” when an instruction that tip will be deposited afterwards has been inputted.

The money handling system of the present invention may further include a memory unit that stores therein information about the charge to be paid for the specific service and information about the tip therefor in a distinguishable manner with respect to money for which a settlement process is performed, and when the money has been taken in by the inlet unit, the amount of the money that has been taken in may be selectively stored in the memory unit as the tip amount.

The money handling system of the present invention may include a money depositing and dispensing device and a register.

A money handling system of the present invention is a money handling apparatus that performs a process of settling a charge for a specific service, including: an inlet unit for taking in money; an amount calculating unit that calculates an amount of the money taken in by the inlet unit; a money storage unit that stores therein the money of which the amount has been calculated by the amount calculating unit; a change dispensing unit that dispenses money equivalent to a change amount as a change from the money storage unit or a change money storage unit; a tip amount identifying unit that identifies a tip amount corresponding to a tip for the specific service; and a control unit that determines the change amount so that a total of an amount of the charge for the specific service, the tip amount identified by the tip amount identifying unit, and the change amount of money to be dispensed as the change by the change dispensing unit becomes equal to the amount calculated by the amount calculating unit, and exerts control so that money equivalent to the change amount is dispensed by the change dispensing unit.

In the money handling system of the present invention, the tip amount identifying unit may acquire the tip amount based on tip amount information transmitted from an external apparatus.

A money handling method of the present invention is a money handling method of performing a process of settling a charge for a specific service, the method including: acquiring a charge amount corresponding to the charge; taking in money; calculating an amount of the money that has been taken in; storing the money that has been taken in and of which the amount has been calculated; dispensing money equivalent to a change amount as a change; and identifying a tip amount for the specific service, and the change amount is determined so that a total of an amount of charge for the specific service, the identified tip amount, and the change amount of money to be dispensed as the change becomes equal to the amount of the money that has been taken in, and money equivalent to the change amount is dispensed.

A money handling apparatus of the present invention is a money handling apparatus that performs a process of depositing money including a charge for a specific service and a tip therefor, including: an inlet unit for taking in money; an amount calculating unit that calculates an amount of the money taken in by the inlet unit; a money storage unit that stores therein the money of which the amount has been calculated by the amount calculating unit; a tip amount identifying unit that identifies a tip amount corresponding to the tip out of the money stored in the money storage unit; a tip recipient identifying unit that identifies a tip recipient who is to receive the tip; and a memory unit that stores therein the tip amount identified by the tip amount identifying unit and the tip recipient identified by the tip recipient identifying unit in a mutually associated manner.

In the money handling apparatus of the present invention, the tip recipient identifying unit may include an ID information input unit that inputs ID information about a person in charge of a deposit process, and the memory unit may store therein the tip amount identified by the tip amount identifying unit and the ID information inputted by the ID information input unit in a mutually associated manner.

In this case, pieces of ID information about plural persons in charge may be grouped, and the memory unit may store therein the tip amount identified by the tip amount identifying unit and information about the group in a mutually associated manner.

In the money handling apparatus of the present invention, the memory unit may store therein the charge paid for the specific service and the tip therefor in a distinguishable manner with respect to the amount of deposited money.

In this case, only money equivalent to the charge to be paid for the specific service may be collected from the money handling apparatus.

The money handling apparatus of the present invention may further include a dispensing unit that dispenses money stored as a tip, and the dispensing unit, when a certain tip recipient performs an operation for dispensing money stored as a tip, may dispense money equivalent to the tip amount associated with the information only about the certain tip recipient.

A money handling method of the present invention is a money handling method of performing a process of depositing money including a charge to be paid for a specific service and a tip therefor, the method including: taking in money; calculating an amount of the money that has been taken in; storing the money that has been taken in and of which the amount has been calculated; identifying a tip amount corresponding to the tip out of the stored money; identifying a tip recipient who is to receive the tip; and storing in a memory unit the identified tip amount and the identified tip recipient in a mutually associated manner.

### BRIEF DESCRIPTION OF DRAWINGS

FIG. 1 is a block diagram of an overall configuration of a money handling system according to an embodiment of the present invention.

FIG. 2 is a perspective view that illustrates an external appearance of a money settlement apparatus included in the money handling system shown in FIG. 1.

FIG. 3 is a block diagram of a configuration of the money settlement apparatus shown in FIG. 2.

FIG. 4 is a perspective view that illustrates an external appearance of a register included in the money handling system shown in FIG. 1.

FIG. 5 is a block diagram of a configuration of the register shown in FIG. 4.

FIG. 6 is a perspective view that illustrates an external appearance of a money handling apparatus (cash accounting apparatus) included in the money handling system shown in FIG. 1.

FIG. 7 is a block diagram of a configuration of the money handling apparatus shown in FIG. 6.

FIG. 8 are views that illustrate display screens displayed on a display unit for operator included in the register shown in FIG. 4 and the like.

FIG. 9 is an explanatory drawing that illustrates a relationship among a service charge amount, a tip amount, change amount, and the like.

FIG. 10 is a flowchart that illustrates a method of handling money performed by the money settlement apparatus and the register of the money handling system shown in FIG. 1.

FIG. 11 is a flowchart that illustrates another method of handling money performed by the money settlement apparatus and the register of the money handling system shown in FIG. 1.

FIG. 12 is a flowchart that illustrates a method of handling money performed by the money handling apparatus of the money handling system shown in FIG. 1.

### DESCRIPTION OF EMBODIMENT

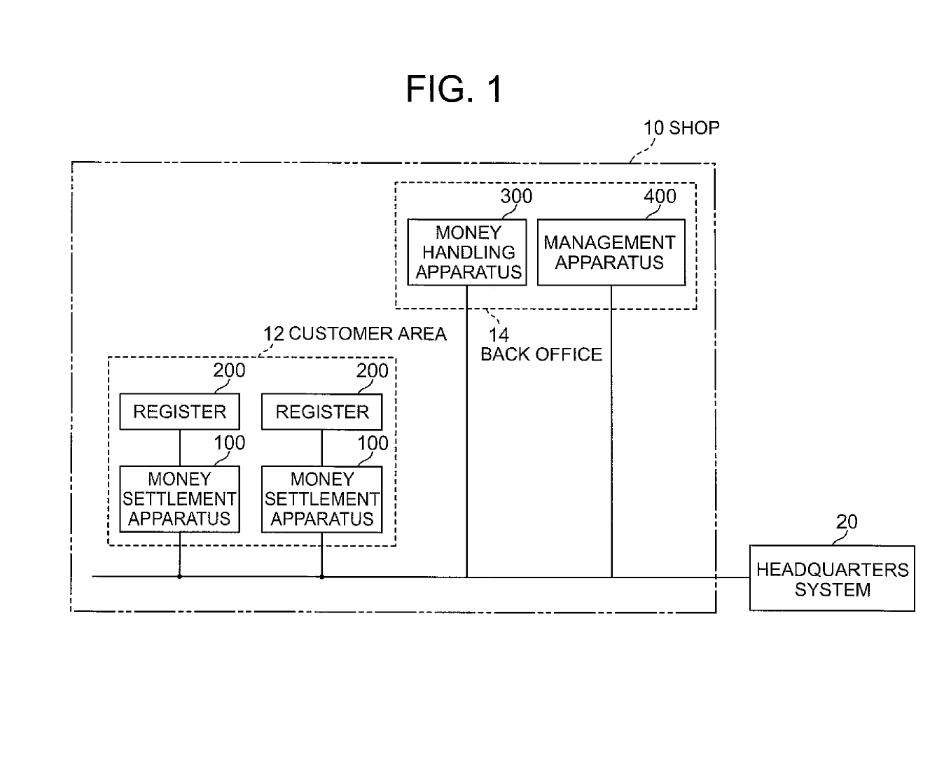

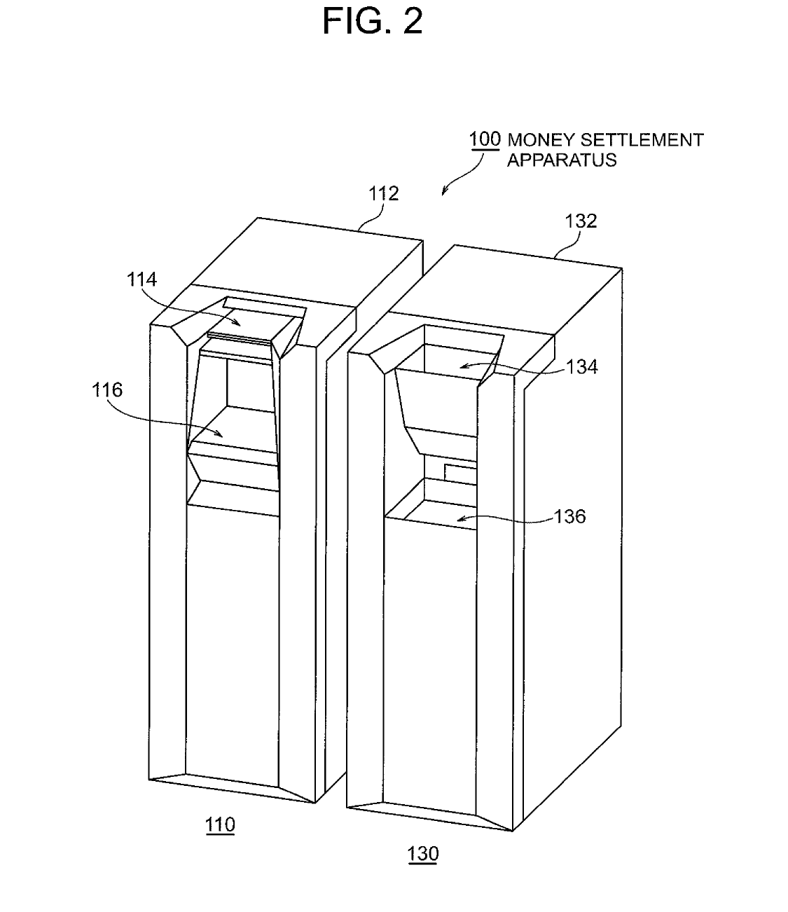

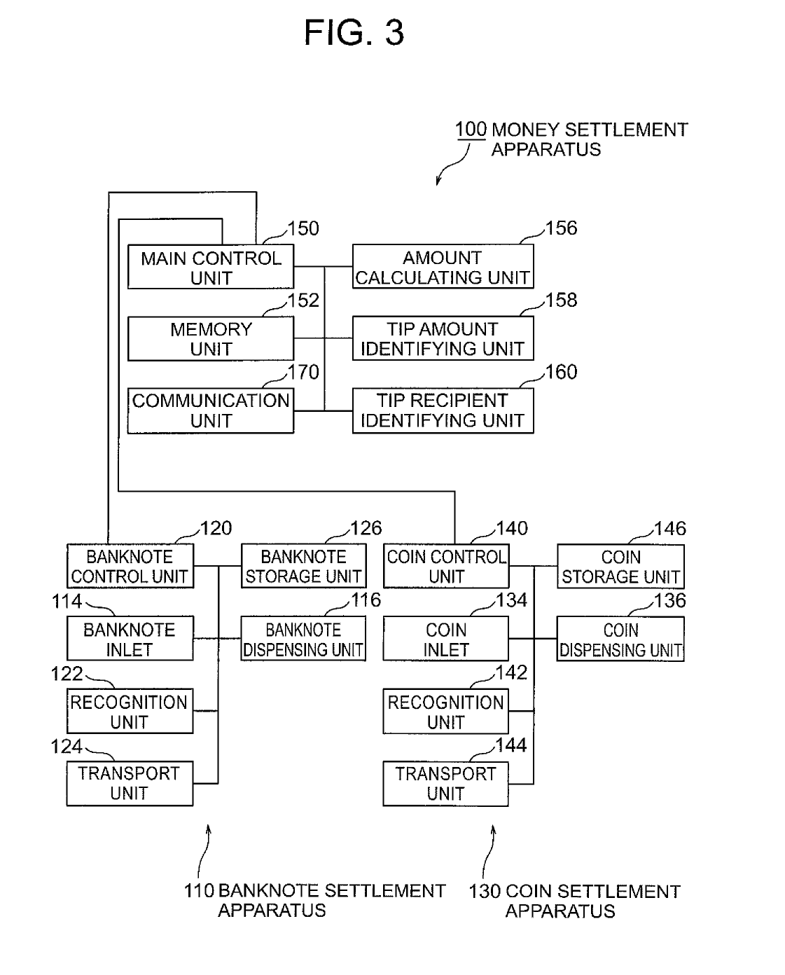

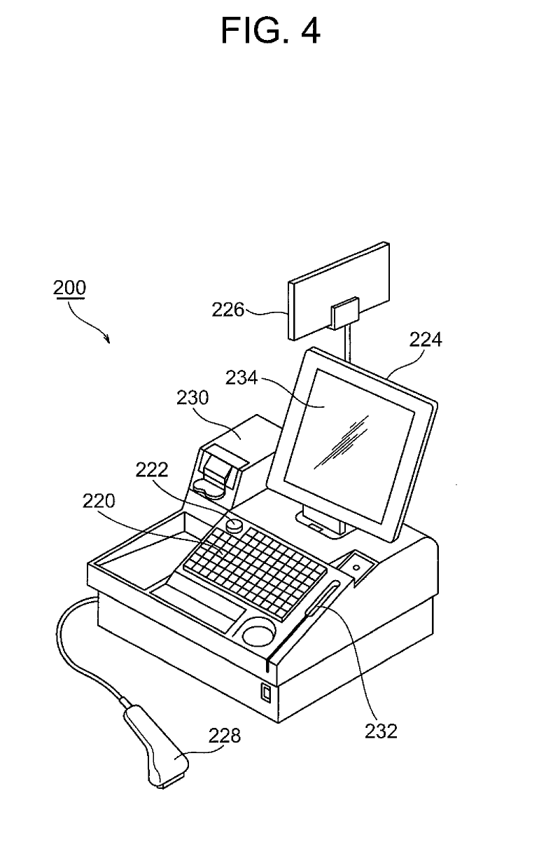

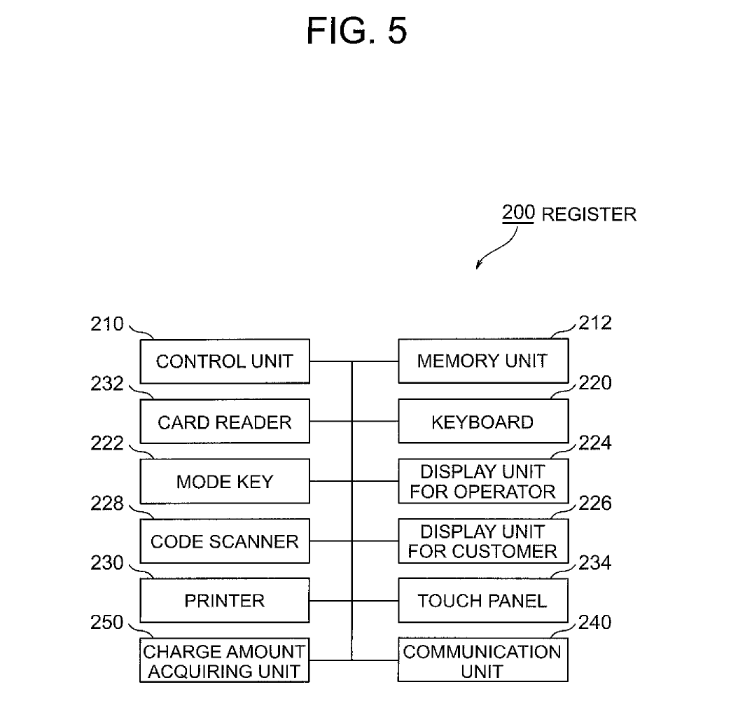

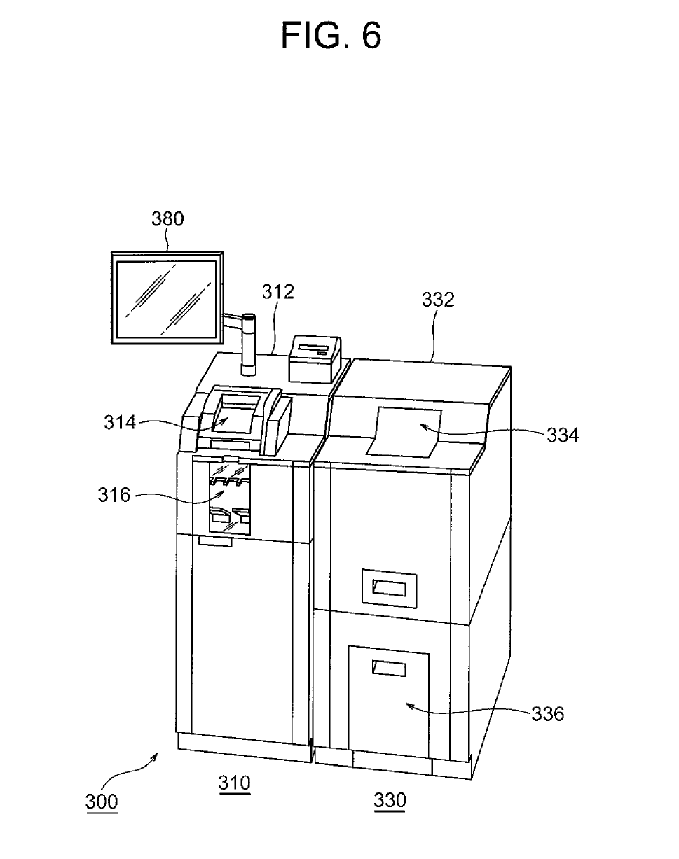

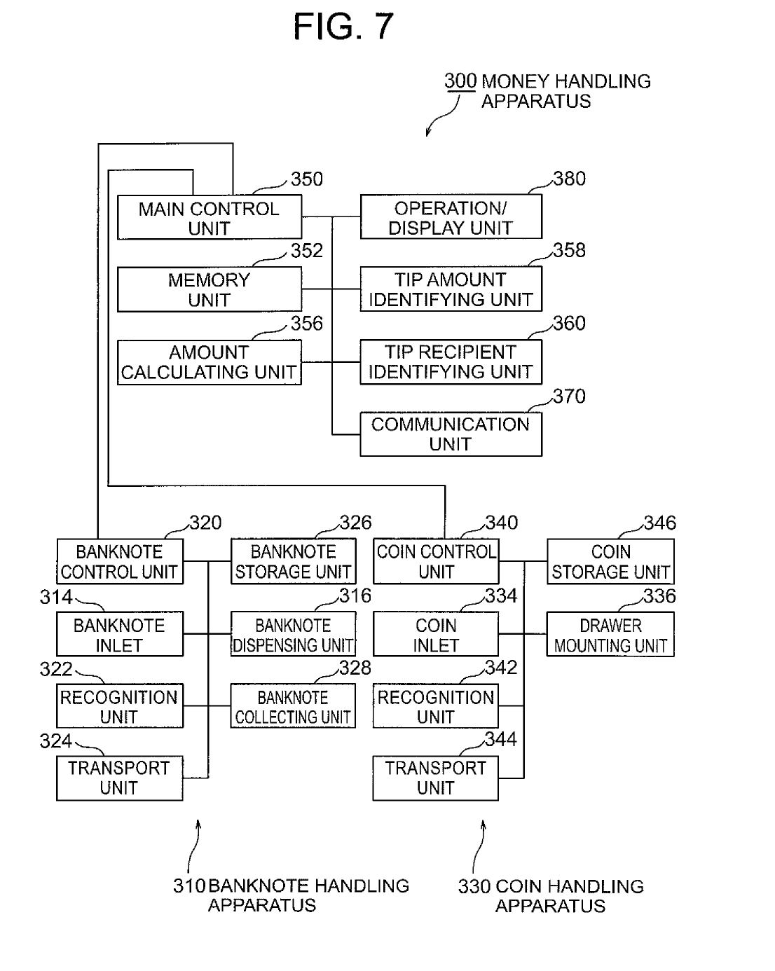

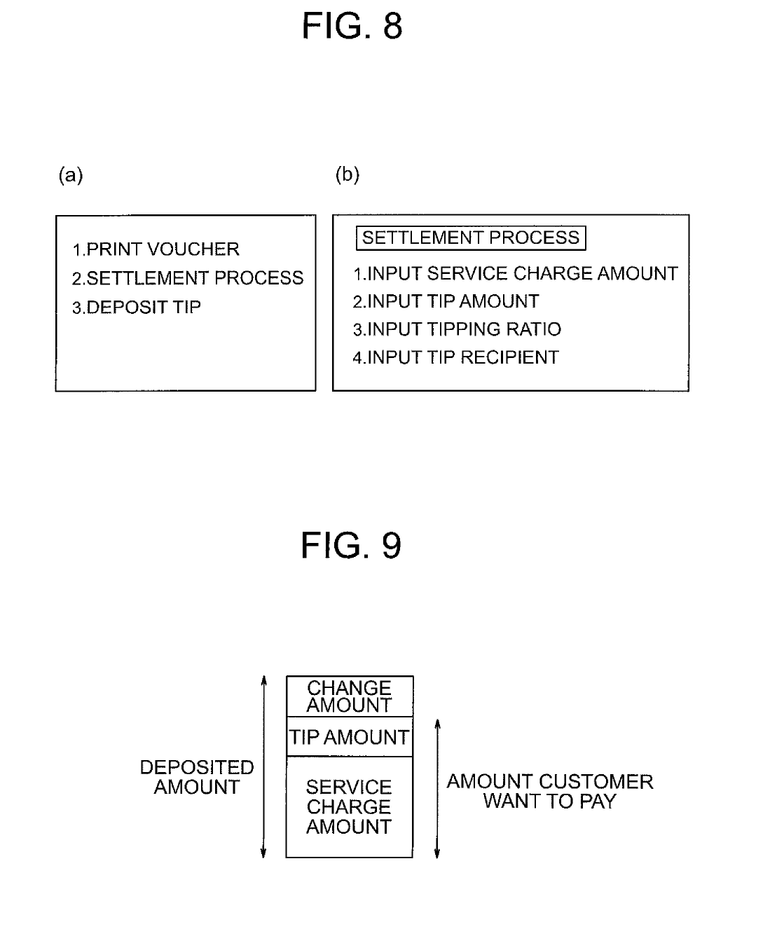

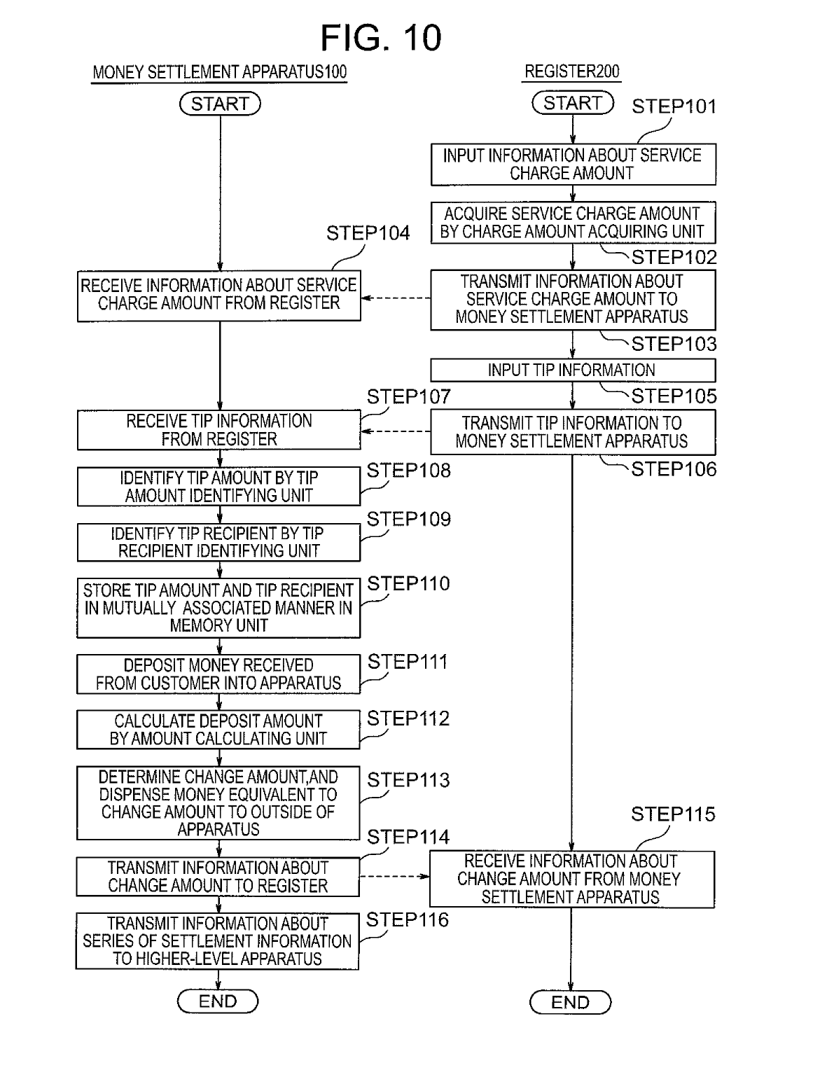

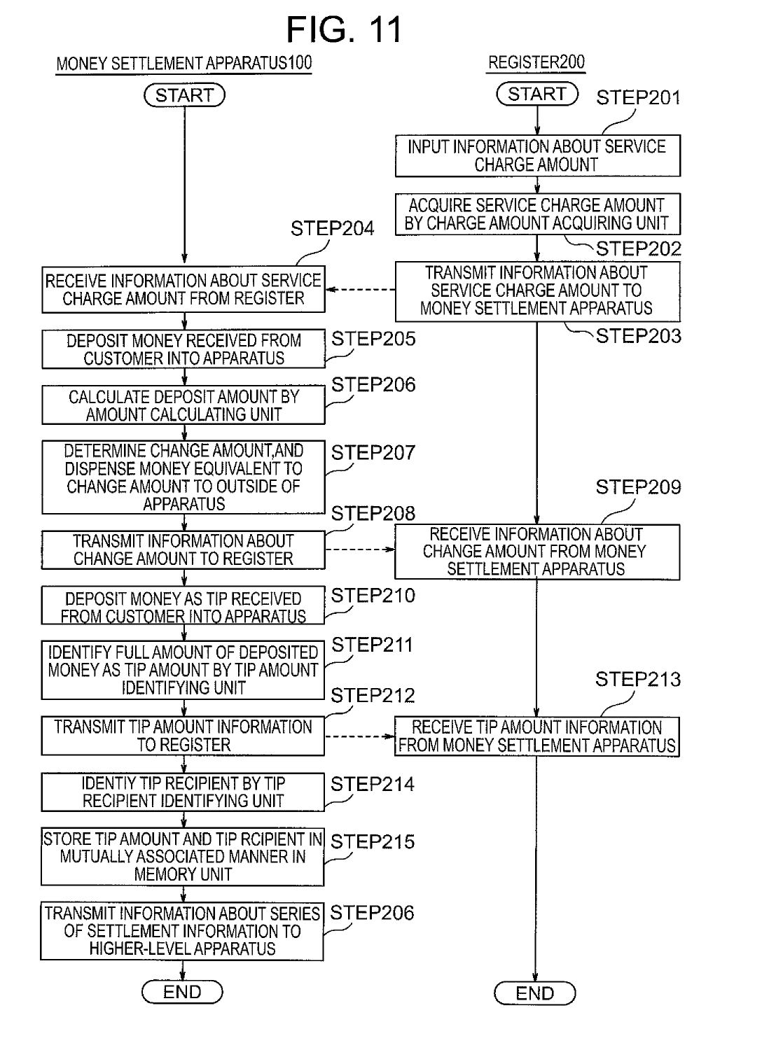

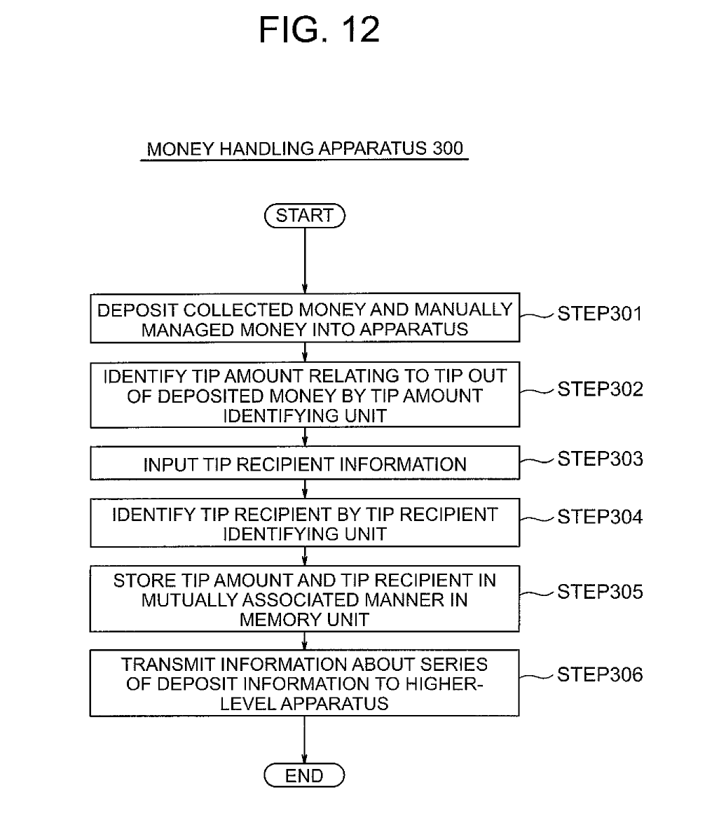

Exemplary embodiments of the present invention are explained below with reference to the accompanying drawings. FIGS. 1 to 12 illustrate a money handling system according to the present embodiment. Among them, FIG. 1 is a block diagram of an overall configuration of the money handling system according to the present embodiment. FIG. 2 is a perspective view that illustrates an external appearance of a money settlement apparatus of the money handling system shown in FIG. 1, and FIG. 3 is a block diagram of a configuration of the money settlement apparatus shown in FIG. 2. FIG. 4 is a perspective view that illustrates an external appearance of a register included in the money handling system shown in FIG. 1, and FIG. 5 is a block diagram of a configuration of the register shown in FIG. 4. FIG. 6 is a perspective view that illustrates an external appearance of a money handling apparatus (cash accounting apparatus) included in the money handling system shown in FIG. 1, and FIG. 7 is a block diagram of a configuration of the money handling apparatus shown in FIG. 6. FIG. 8 are views that illustrate display screens displayed on a display unit for operator included in the register shown in FIG. 4 and the like, and FIG. 9 is an explanatory drawing that illustrates a relationship among a service charge amount, a tip amount, a change amount, and the like. FIGS. 10 and 11 are flowcharts that illustrate a method of handling money performed by the money settlement apparatus and the register of the money handling system shown in FIG. 1. FIG. 12 is a flowchart that illustrates a method of handling money performed by the money handling apparatus of the money handling system shown in FIG. 1.

The money handling system according to the present embodiment can be installed as a commercial system in facilities such as restaurants and bars, clubs, hotels, and the like, and an example will be explained below in which the money handling system according to the present embodiment is installed in a restaurant.

Overall Configuration of Money Handling System

Referring to FIG. 1, a restaurant shop 10 includes a customer area 12 and a back office 14. The customer area 12 is a place where customers eat and drink and pay the charge for the food and drink they have consumed. The back office 14 is an off-limit region into which customers are not allowed to enter and is the office of the shop 10, for example. As shown in FIG. 1, two sets, for example, of a combination of a money settlement apparatus 100 and a register 200 are installed on the customer area 12. Such a combination of the money settlement apparatus 100 and the register 200 is placed on a register counter installed on the customer area 12. The money settlement apparatus 100 performs a settlement process including taking in money received from a customer and dispensing money as a change. The register 200 performs processing of data and the like of the food and drink consumed by customers and manages the money settlement apparatus 100. In FIG. 1, two sets of the combination of the money settlement apparatus 100 and the register 200 have been shown; however, the number is not limited to two. For example, only one set of the combination of the money settlement apparatus 100 and the register 200 may be installed at the register counter, or three or more sets of the combination may be installed.

The money settlement apparatus 100 and the register 200 are operated by a clerk present on the customer area 12. When a customer proceeds to make payment for the food and drink consumed by the customer, the clerk inputs data about the food and drink consumed by the customer into the register 200 and deposits the money he received from the customer into the money settlement apparatus 100. When the money settlement apparatus 100 dispenses money as the change, the clerk hands over the dispensed money to the customer. When these operations are completed, a series of the settlement processes at the restaurant ends. In the present embodiment, in the settlement processes, money depositing and dispensing processes are performed mechanically and automatically while considering the tips received from the customers.

Referring to FIG. 1, a money handling apparatus (cash accounting apparatus) 300 and a management apparatus 400 are installed in the back office 14. In the present embodiment, the customer area 12 and the back office 14 are in communicably connected to each other via a network such as a local area network (LAN). The money handling apparatus 300 is communicably connected to each of the money settlement apparatuses 100. The money handling apparatus 300 can perform a process of dispensing money as the change reserve money to be loaded into each of the money settlement apparatuses 100 or a process of depositing money collected from each of the money settlement apparatuses 100, for example. The management apparatus 400 is communicably connected to each of the registers 200 and manages data about the food and drink served on the customer area 12.

The restaurant shop 10 illustrated in FIG. 1 can be a part of a franchised restaurant, for example. In such a case, each shop 10 is communicably connected to a headquarters system 20, and pieces of information about all the shops 10 are transmitted to the headquarters system 20. The present embodiment is not limited to the configuration explained above, and the restaurant shop 10 illustrated in FIG. 1 may not be communicably connected to any external system such as the headquarters system 20, and the money handling system included in the shop 10 may be a stand-alone system.

Detailed configurations of the money settlement apparatus 100, the register 200, the money handling apparatus 300 and the like installed in the restaurant shop 10 will be explained below with reference to FIGS. 2 to 7.

Configuration of Money Settlement Apparatus 100

The money settlement apparatus 100 includes a banknote settlement apparatus 110 that performs a settlement process of depositing and dispensing banknotes, and a coin settlement apparatus 130 that performs a settlement process of depositing and dispensing coins. A configuration of the money settlement apparatus 100 will be explained with reference to FIGS. 2 and 3.

Referring to FIG. 2, the banknote settlement apparatus 110 includes a housing 112, a banknote inlet 114 for taking in banknotes received from a customer into the apparatus body, and a banknote dispensing unit 116 for dispensing money as a change from the inside of the apparatus to an outside of the apparatus. Referring to FIG. 3, a recognition unit 122, a transport unit 124, and a banknote storage unit 126 are arranged inside the apparatus body of the banknote settlement apparatus 110. Banknotes taken in from the banknote inlet 114 into the apparatus body are transported by the transport unit 124. The recognition unit 122 recognizes the denomination, authenticity, fitness, old/new status, and the like of the banknotes transported by the transport unit 124. The banknote storage unit 126 stores therein the banknotes recognized by the recognition unit 122 by denomination. The banknote storage unit 126 can be a stacking type unit in which banknotes are stacked by denomination, or can be a tape reel type unit in which each banknote is sandwiched between plural tapes by denomination and the tapes are wound up in this state together with the banknotes. The banknote dispensing unit 116 dispenses the banknotes stored in the banknote storage unit 126 to the outside of the apparatus body as a change. The banknote settlement apparatus 110 can include a banknote storage unit dedicated for change separately from the banknote storage unit 126. In this case, the banknote dispensing unit 116 may dispense the banknotes as a change from the banknote storage unit for change to the outside of the apparatus body.

Referring to FIG. 3, the banknote settlement apparatus 110 includes a banknote control unit 120 that controls the components of the banknote settlement apparatus 110. The banknote inlet 114, the banknote dispensing unit 116, the recognition unit 122, the transport unit 124, the banknote storage unit 126, and the like are connected to the banknote control unit 120.

Referring to FIG. 2, the coin settlement apparatus 130 includes a housing 132, a coin inlet 134 for taking in coins received from a customer into the apparatus body, and a coin dispensing unit 136 for dispensing coins as a change from the inside of the apparatus body to the outside of the apparatus body. Referring to FIG. 3, a recognition unit 142, a transport unit 144, and a coin storage unit 146 are arranged inside the apparatus body of the coin settlement apparatus 130. Coins taken in from the coin inlet 134 into the apparatus body are transported by the transport unit 144. The recognition unit 142 recognizes the denomination, authenticity, fitness, old/new status, and the like of the coins transported by the transport unit 144. The coin storage unit 146 stores therein the coins recognized by the recognition unit 142 by denomination. The coin dispensing unit 136 dispenses the coins stored in the coin storage unit 146 to the outside of the apparatus body as a change. The coin settlement apparatus 130 can include a coin storage unit dedicated for change separately from the coin storage unit 146. In this case, the coin dispensing unit 136 may dispense coins as a change from the coin storage unit for change to the outside of the apparatus body.

Referring to FIG. 3, the coin settlement apparatus 130 includes a coin control unit 140 that controls the components of the coin settlement apparatus 130. The coin inlet 134, the coin dispensing unit 136, the recognition unit 142, the transport unit 144, the coin storage unit 146, and the like are connected to the coin control unit 140.

Referring to FIG. 3, the money settlement apparatus 100 includes a main control unit 150 that is connected to the banknote control unit 120 and the coin control unit 140. The main control unit 150 controls the components of the banknote settlement apparatus 110 and the coin settlement apparatus 130 via the banknote control unit 120 and the coin control unit 140. A memory unit 152, an amount calculating unit 156, a tip amount identifying unit 158, a tip recipient identifying unit 160, a communication unit 170, and the like are connected to the main control unit 150. The main control unit 150, the memory unit 152, the amount calculating unit 156, the tip amount identifying unit 158, the tip recipient identifying unit 160, the communication unit 170, and the like are arranged inside any one of the banknote settlement apparatus 110 and the coin settlement apparatus 130.

The memory unit 152 includes a read-only memory (ROM) or a hard disk drive (HDD) that stores therein various computer programs and data used for controlling the banknote settlement apparatus 110 and the coin settlement apparatus 130, a random access memory (RAM) used as a work area for loading and executing the computer programs, and the like. Moreover, the memory unit 152 stores therein the number of the banknotes and the coins stored in the banknote storage unit 126 and the coin storage unit 146 (inventory amount) by denomination. Furthermore, the memory unit 152 stores therein the number of the banknotes and the coins deposited into the banknote settlement apparatus 110 and the coin settlement apparatus 130 by denomination and the number of the banknotes and the coins dispensed from the banknote settlement apparatus 110 and the coin settlement apparatus 130 as change by denomination. When storing the amount of the money for which the settlement process has been completed, the memory unit 152 is capable of storing therein the information about the charge for a specific service including the charge for the food and drink that have been served to a customer and the tip given by the customer therefor distinguishably from each other. The memory unit 152 also stores therein the amount of change reserve money, which is the amount of the banknotes and the coins to be dispensed from the money settlement apparatus 100 as a change. Furthermore, the memory unit 152 stores therein the tip amount identified by the tip amount identifying unit 158 and the recipient of the tip identified by the tip recipient identifying unit 160 in a mutually associated manner. Details of the contents that are stored in the memory unit 152 will be explained later.

The amount calculating unit 156 calculates, based on the results of recognition of the banknotes and the coins by the recognition units 122 and 142, the amount of the money that has been taken into the banknote settlement apparatus 110 and the coin settlement apparatus 130. The tip amount identifying unit 158 identifies the amount of tip given by a customer for the specific service provided to the customer. The tip recipient identifying unit 160 identifies the recipient of the tip, such as the clerk who is to receive the tip, for respective tips. Detailed configurations of the amount calculating unit 156, the tip amount identifying unit 158, and the tip recipient identifying unit 160 will be explained later.

The communication unit 170 is communicably connected to the apparatuses other than the money settlement apparatus 100, specifically, to the register 200, the money handling apparatus 300, the management apparatus 400, the headquarters system 20, and the like. The communication unit 170 can transmit to the money handling apparatus 300, the management apparatus 400, the headquarters system 20, and the like data about the inventory amount of the banknotes and the coins stored in the banknote storage unit 126 and the coin storage unit 146, deposit and dispense data about the number of the banknotes and the coins that have been deposited into the banknote settlement apparatus 110 and the coin settlement apparatus 130 by denomination as well as the banknotes and the coins that have been dispensed from these units by denomination.

Configuration of Register 200

Next, a configuration of the registers 200 provided corresponding to each of the money settlement apparatuses 100 will be explained below with reference to FIGS. 4 and 5. FIG. 4 is a perspective view that illustrates an external appearance of the register 200 according to the present embodiment. Referring to FIG. 4, the register 200 includes a keyboard 220, a mode key 222, a display unit for operator 224, a display unit for customer 226, a code scanner 228, a printer 230, a card reader 232, and the like. A touch panel 234 as an input device is mounted by laminating on the display unit for operator 224.

Referring to FIG. 5, the register 200 includes a control unit 210 that controls the components of the register 200. A memory unit 212, the keyboard 220, the mode key 222, the display unit for operator 224, the display unit for customer 226, the code scanner 228, the printer 230, the card reader 232, the touch panel 234, a communication unit 240, and the like are connected to the control unit 210. In present embodiment, a charge amount acquiring unit 250 is provided that acquires the amount of the charge for a specific service including the charge for the food and drink that have been served to the customer (hereinafter, service charge amount).

The memory unit 212 includes a ROM or an HDD that stores therein various computer programs and data that control the register 200, and a RAM and the like that is used as a work area for loading and executing the computer programs. The memory unit 212 can store therein information about the food, drink, and the like served in the restaurant (specifically, information about the price of each food dish and drink), information about restaurant clerks (for example, identification (ID) information of each clerk), information about customers (for example, ID information of each customer), and the like.

The communication unit 240 is communicably connected to the apparatuses other than the register 200, specifically, to the money settlement apparatus 100, the money handling apparatus 300, the management apparatus 400, the headquarters system 20, and the like.

The keyboard 220 sends a signal to the control unit 210 in accordance with keys thereof operated by the operator. The mode key 222 switches an operation mode of the register 200 when it is operated by the operator. The display unit for operator 224 and the display unit for customer 226 display the data stored in the memory unit 212 or the data inputted via the keyboard 220, the mode key 222, or the touch panel 234. The code scanner 228 can optically read information recorded on an ID card and the like carried by the clerks (ID information of the clerks). The printer 230 can print the charge for the service provided to the customer, that is, the amount of the charge for food, drink, and the like (service charge amount) on a voucher. When a customer presents a credit card to pay the charge, the card reader 232 is used to scan the credit card.

The display unit for operator 224 displays the content to be printed on the voucher, such as the service charge amount, soft keys such as the numeral keys and the mode key, the inventory amount of the money present in the money settlement apparatus 100, and the like. The clerk can input numerical values and the mode by using the keyboard 220 and the mode key 222. Alternatively, the numerical values or the mode can be inputted by operating the touch panel 234 that has been laminated on the display unit for operator 224. The display unit for customer 226 displays contents such as the service charge amount, among the content displayed on the display unit for operator 224, to the customer.

The charge amount acquiring unit 250 acquires the service charge amount based on the information (for example, names of food dishes and drinks or total price thereof) inputted by the clerk by using the keyboard 220 and the touch panel 234.

Configuration of Money Handling Apparatus (Cash Accounting Apparatus) 300

Next, a configuration of the money handling apparatus 300 installed in the back office 14 will be explained. The money handling apparatus 300 includes a banknote handling apparatus 310 and a coin handling apparatus 330. The banknote handling apparatus 310 dispenses banknotes as the change reserve money to be loaded into the banknote settlement apparatus 110 or deposits banknotes collected from the banknote settlement apparatus 110. The coin handling apparatus 330 dispenses coins as the change reserve money to be loaded into the coin settlement apparatus 130 or deposits the coins collected from the coin settlement apparatus 130. A configuration of the money handling apparatus 300 will be explained with reference to FIGS. 6 and 7.

Referring to FIG. 6, the banknote handling apparatus 310 includes a housing 312, a banknote inlet 314 that takes banknotes collected from the banknote settlement apparatus 110 into the apparatus body, and a banknote dispensing unit 316 that dispenses banknotes as the change reserve money to be loaded into the banknote settlement apparatus 110 from the inside of the apparatus body to the outside of the apparatus body. Referring to FIG. 7, a recognition unit 322, a transport unit 324, a banknote storage unit 326, and a banknote collecting unit 328 are arranged inside the apparatus body of the banknote handling apparatus 310. The banknotes taken in from the banknote inlet 314 into the apparatus body are transported by the transport unit 324. The recognition unit 322 recognizes the denomination, authenticity, fitness, old/new status, and the like of the banknotes transported by the transport unit 324. The banknote storage unit 326 stores therein the banknotes recognized by the recognition unit 322 by denomination. The banknote storage unit 326 can be a stacking type unit in which the banknotes are stacked by denomination, or can be a tape reel type unit in which each banknote is sandwiched between plural tapes by denomination and the tapes are wound up in this state together with the banknotes. The banknote dispensing unit 316 dispenses the banknote stored in the banknote storage unit 326 to the outside of the apparatus body as the change reserve money to be loaded into the banknote settlement apparatus 110. The banknote handling apparatus 310 can include a banknote storage unit dedicated for the change reserve money separately from the banknote storage unit 326. In this case, the banknote dispensing unit 316 may dispense the banknotes as the change reserve money from this banknote storage unit for change reserve money to the outside of the apparatus body. The banknote collecting unit 328 stores therein overflowing banknotes that cannot be stored in the banknote storage unit 326 and banknotes of the denomination that has not been set to the banknote storage unit 326. In addition, banknotes that are excessive in the collection operation are collected by the banknote collecting unit 328 from the banknote storage unit 326.

Referring to FIG. 7, the banknote handling apparatus 310 includes a banknote control unit 320 that controls the components of the banknote handling apparatus 310. The banknote inlet 314, the banknote dispensing unit 316, the recognition unit 322, the transport unit 324, the banknote storage unit 326, the banknote collecting unit 328, and the like are connected to the banknote control unit 320.

Referring to FIG. 6, the coin handling apparatus 330 includes a housing 332, a coin inlet 334 that take coins collected from the coin settlement apparatus 130 into the apparatus body, and a drawer mounting unit 336. A drawer that stores therein coins as the change reserve money to be loaded into the coin settlement apparatus 130 can be mounted in the drawer mounting unit 336. Referring to FIG. 7, a recognition unit 342, a transport unit 344, and a coin storage unit 346 are arranged inside the apparatus body of the coin handling apparatus 330. The coins taken in from the coin inlet 334 into the apparatus body are transported by the transport unit 344. The recognition unit 342 recognizes the denomination, authenticity, fitness, old/new status, and the like of the coins transported by the transport unit 344. The coin storage unit 346 stores therein the coins recognized by the recognition unit 342 by denomination. The coins stored in the coin storage unit 346 are transported to the drawer mounted on the drawer mounting unit 336, and by drawing the drawer mounting unit 336 itself, the coins stored inside the drawer can be loaded into the coin settlement apparatus 130 or collected therefrom.

Referring to FIG. 7, the coin handling apparatus 330 includes a coin control unit 340 that controls the components of the coin handling apparatus 330. The coin inlet 334, the drawer mounting unit 336, the recognition unit 342, the transport unit 344, the coin storage unit 346, and the like are connected to the coin control unit 340.

Referring to FIG. 7, the money handling apparatus 300 includes a main control unit 350 that is connected to the banknote control unit 320 and the coin control unit 340. The main control unit 350 controls the components of the banknote handling apparatus 310 and the coin handling apparatus 330 by using the banknote control unit 320 and the coin control unit 340. An operation/display unit 380, a memory unit 352, an amount calculating unit 356, a tip amount identifying unit 358, a tip recipient identifying unit 360, a communication unit 370, and the like are connected to the main control unit 350. Referring to FIG. 6, the operation/display unit 380 is mounted on an upper surface of the banknote handling apparatus 310. The main control unit 350, the memory unit 352, the amount calculating unit 356, the tip amount identifying unit 358, the tip recipient identifying unit 360, the communication unit 370, and the like are arranged in any one of the banknote handling apparatus 310 and the coin handling apparatus 330.

The memory unit 352 includes a ROM or an HDD that store therein various computer programs and data used for controlling the banknote handling apparatus 310 and the coin handling apparatus 330, a RAM used as a work area for loading and executing the computer programs, and the like. Moreover, the memory unit 352 stores therein the number of the banknotes and the coins stored in the banknote storage unit 326 and the coin storage unit 346 (the inventory amount) by denomination. Furthermore, the memory unit 352 stores therein the number of the banknotes and the coins deposited into the banknote handling apparatus 310 and the coin handling apparatus 330 by denomination and the number of the banknotes and the coins dispensed from the banknote handling apparatus 310 and the coin handling apparatus 330 by denomination. When storing the amount of the money for which the depositing process has been completed, the memory unit 352 can store therein the information about the charge for a specific service including the charge for the food and drink that have been served to a customer and the amount of tip given by the customer therefor distinguishably from each other. The memory unit 352 also stores therein the amount of change reserve money, which is the amount of the banknotes and the coins to be replenished into the money settlement apparatus 100. Furthermore, the memory unit 352 stores therein the amount of tip identified by the tip amount identifying unit 358 and the recipient of the tip identified by the tip recipient identifying unit 360 in a mutually associated information. Details of the contents that are stored in the memory unit 352 will be explained later.

The amount calculating unit 356 calculates, based on the results of recognition of the banknotes and the coins by the recognition units 322 and 342, the amount of the money that has been taken into the banknote handling apparatus 310 and the coin handling apparatus 330. The tip amount identifying unit 358 identifies the amount of tip given by a customer for the specific service provided to the customer. The tip recipient identifying unit 360 identifies the recipient of the tip, such as the clerk who is to receive the tip, for respective tips. Detailed configurations of the amount calculating unit 356, the tip amount identifying unit 358, and the tip recipient identifying unit 360 will be explained later.

The communication unit 370 is communicably connected to the apparatuses other than the money handling apparatus 300, specifically, to the money settlement apparatus 100, the register 200, the management apparatus 400, the headquarters system 20, and the like. The communication unit 370 can transmit to the management apparatus 400, the headquarters system 20, and the like data about the inventory amount of the banknotes and the coins stored in the banknote storage unit 326 and the coin storage unit 346, deposit and dispense data about the number of the banknotes and the coins that have been deposited into the banknote handling apparatus 310 and the coin handling apparatus 330 by denomination as well as the banknotes and the coins that have been dispensed from these units by denomination, and collection data about the number of the banknotes and the coins collected from the banknote handling apparatus 310 and the coin handling apparatus 330 by denomination.

Operations of Money Settlement Apparatus 100 and Register 200

Next, operations of the money handling system having the above-explained configuration, in particular, operations of the money settlement apparatus 100 and the register 200 will be explained with reference to the flowcharts illustrated in FIGS. 10 and 11.

When a customer sitting on a table of the restaurant shop 10 on the customer area 12 shows willingness to a clerk to settle the charge for the food and drink consumed by the customer, the clerk performs a voucher printing operation on the register 200 placed on the register counter. Before the clerk starts the voucher printing operation, a standby screen illustrated in FIG. 8(a) is displayed on the display unit for operator 224 of the register 200. When the clerk selects the item “1. PRINT VOUCHER” by operating the keyboard 220, the touch panel 234, or the like, it becomes possible to input on the register 200 names of the food dishes and drinks that were served to the customer. When the clerk inputs the names of the food dishes and drinks by operating the keyboard 220, the touch panel 234, or the like to calculate the service charge amount (STEP 101), a voucher showing the names of the food dishes and drinks and the total amount of the charge therefor is printed by the printer 230. In this process, the charge amount acquiring unit 250 of the register 200 acquires the total amount of the food and drink served to the customer (service charge amount) based on the information inputted by the clerk (STEP 102). The information about the service charge amount acquired by the charge amount acquiring unit 250 is transmitted from the register 200 to the money settlement apparatus 100 (STEP 103 and STEP 104). The clerk hands over the voucher printed by the printer 230 of the register 200 to the customer and requests the customer to pay the charge. It is not necessary for the clerk to input the information about the service charge amount to the register 200 and get the voucher printed by the printer 230. That is, the clerk may prepare a handwritten voucher and hand over it to the customer.

The customer who has received the voucher from the clerk pays the charge to the clerk. The customer may pay an amount including a tip or may pay an amount devoid of a tip. In the former case, the customer tells the amount of the tip to the clerk. Instead of telling the tip amount, the customer may tell a tipping ratio, which is a ratio of the tip to the total amount of the food and drink (the service charge amount) (for example, a tipping ratio 15% of the total amount) to the clerk. Instead of telling the tip amount to the clerk, the customer may tell the amount of change to be returned to the customer. The flowchart illustrated in FIG. 10 illustrates a flow of operations in an example where the customer pays the amount including a tip to the clerk upon receiving the voucher. If the customer pays an amount without a tip to the clerk upon receiving the voucher, the customer may pay the tip to the clerk after receiving the change from the clerk. Operations in this case will be explained later with reference to the flowchart illustrated in FIG. 11.

Instead of paying the charge in cash, the customer may hand over his credit card to the clerk and ask the clerk to process the payment with the credit card. Operations performed in this case will also be explained later.

After having received the money or the credit card from the customer, the clerk operates the money settlement apparatus 100 and the register 200 placed on the register counter to perform the settlement process. More specifically, when the clerk selects the item “2. SETTLEMENT PROCESS” by operating the keyboard 220, the touch panel 234, or the like, on a screen of the display unit for operator 224 of the register 200 on which the standby screen illustrated in FIG. 8(a) is being displayed, input of the information about the tip via the register 200 is enabled. Examples of the information about the tip include the tip amount itself and the tipping ratio to the total amount of the charge for the food and drink (service charge amount). More specifically, when the clerk selects the item “2. SETTLEMENT PROCESS” on the standby screen illustrated in FIG. 8(a), an input selection screen illustrated in FIG. 8(b) is displayed on the display unit for operator 224 of the register 200. When the clerk selects the item “2. INPUT TIP AMOUNT”, the tip amount itself can be inputted by operating the keyboard 220, the touch panel 234, or the like. When the clerk selects the item “3. INPUT TIPPING RATIO”, the tipping ratio to the total amount of the charge for the food and drink (the service charge amount) can be inputted by operating the keyboard 220, the touch panel 234, or the like. When the clerk inputs the tip information (specifically, the tip amount or the tipping ratio) (STEP 105), the inputted tip information is transmitted from the register 200 to the money settlement apparatus 100 (STEP 106 and STEP 107). The tip amount identifying unit 158 of the money settlement apparatus 100 identifies the tip amount based on the information received from the register 200 (STEP 108). To explain in more detail, if the tip amount itself has been inputted to the register 200, the tip amount identifying unit 158 identifies the inputted tip amount itself as the tip amount. If the tipping ratio has been inputted to the register 200 instead of the tip amount itself, the tip amount identifying unit 158 calculates the tip amount by multiplying the service charge amount acquired by the charge amount acquiring unit 250 with the inputted tipping ratio.

For the tip information, information about the tip recipient, which is information about the clerk who is to receive the tip, can be inputted to the register 200 in addition to the tip amount and the tip amount ratio. More specifically, if the clerk selects the item “4. INPUT TIP RECIPIENT” by operating the keyboard 220, the touch panel 234, or the like on an input selection screen of the display unit for operator 224 of the register 200 illustrated in FIG. 8(b), the information about the tip recipient can be inputted to the register 200. To explain in more detail, the clerk scans own ID card with the code scanner 228 so that the ID information of the clerk is read by the code scanner 228, and then the read ID information is inputted to the register 200 as the information about the tip recipient (STEP 105). When the information about the tip recipient is inputted to the register 200, the information is transmitted from the register 200 to the money settlement apparatus 100 (STEP 106 and STEP 107). The tip recipient identifying unit 160 of the money settlement apparatus 100 identifies the tip recipient for the respective tips based on the information received from the register 200 (STEP 109). More specifically, the tip recipient identifying unit 160 identifies the ID information about the clerk read by the code scanner 228 of the register 200. As explained above, the tip recipient identifying unit 160 includes an ID information input unit that allows inputting the ID information of a person who performs the settlement process.

When the tip amount is identified by the tip amount identifying unit 158 and the tip recipient for the respective tips is identified by the tip recipient identifying unit 160, the tip amount identified by the tip amount identifying unit 158 and the tip recipient identified by the tip recipient identifying unit 160 are associated with each other and the mutually associated pieces of information are stored in the memory unit 152 (STEP 110).

If the clerk has not inputted the information about the service charge amount to the register 200 but has prepared the handwritten voucher and handed over it to the customer, then the clerk, after having received the money from the customer, selects the item “1. INPUT SERVICE CHARGE AMOUNT” when the input selection screen illustrated in FIG. 8(b) has been displayed on the display unit for operator 224 of the register 200. The clerk inputs the total amount of the charge for the food and drink served to the customer itself to the register 200 as the service charge amount by operating the keyboard 220, the touch panel 234, and the like (STEP 101). As a result, the charge amount acquiring unit 250 of the register 200 acquires the service charge amount based on the information inputted by the clerk (STEP 102). The information about the service charge amount acquired by the charge amount acquiring unit 250 is transmitted from the register 200 to the money settlement apparatus 100 (STEP 103 and STEP 104).

The clerk deposits the money received from the customer to the banknote settlement apparatus 110 and the coin settlement apparatus 130 of the money settlement apparatus 100 without performing any process thereto (STEP 111). The amount calculating unit 156 calculates the amount of the money having been taken into the banknote settlement apparatus 110 and the coin settlement apparatus 130 based on the results of the recognition of the banknotes and the coins by the recognition units 122 and 142 (STEP 112).

The main control unit 150 of the money settlement apparatus 100 determines the change amount so that the total amount of the service charge amount transmitted from the register 200 (that is, the service charge amount acquired by the charge amount acquiring unit 250), the tip amount identified by the tip amount identifying unit 158, and the amount of change of the banknotes and the coins to be dispensed as the change by the banknote dispensing unit 116 and the coin dispensing unit 136 becomes equal to the amount calculated by the amount calculating unit 156 (that is, the amount deposited to the money settlement apparatus 100). Moreover, the main control unit 150 exerts control so that the money equivalent to thus determined change amount is dispensed by the banknote dispensing unit 116 and the coin dispensing unit 136 (STEP 113). The above-mentioned control will be explained below with reference to FIG. 9.

Referring to FIG. 9, the amount the customer wants to pay, of the amount of money handed by the customer to the clerk for the settlement process (that is, the amount deposited to the money settlement apparatus 100), includes the service charge amount, which is the charge for the food and drink itself, and the tip amount. The amount obtained by subtracting the amount that the customer wants to pay from the amount of the money handed by the customer to the clerk will be equal to the change amount. More specifically, the change amount is the amount obtained by subtracting the total amount of the service charge amount and the tip amount from the amount of the money handed by the customer to the clerk. As explained above, the main control unit 150 determines the change amount by subtracting the total amount of the service charge amount transmitted from the register 200 and the tip amount identified by the tip amount identifying unit 158 from the amount calculated by the amount calculating unit 156 (the amount deposited to the money settlement apparatus 100). Then, the main control unit 150 exerts control so that the money equivalent to the change amount is dispensed from the banknote dispensing unit 116 and the coin dispensing unit 136. The clerk returns the money dispensed as the change from the money settlement apparatus 100 to the customer.

While the settlement process is progressing, the memory unit 152 stores therein the amount of the money handled in the settlement. In this process, among the amount of the money handled in the settlement, the memory unit 152 stores therein the charge for the specific service including the charge for the food and drink that have been served to the customer and the tip therefor distinguishably from each other. More specifically, the memory unit 152 stores therein the service charge amount acquired by the charge amount acquiring unit 250 of the register 200 and the tip amount identified by the tip amount identifying unit 158, respectively.

The information about the change amount calculated by the main control unit 150 is stored in the memory unit 152 and transmitted from the money settlement apparatus 100 to the register 200 (STEP 114 and STEP 115). Accordingly, the control unit 210 of the register 200 can manage even the information about the change amount. The series of settlement information explained above is transmitted by the communication unit 170 of the money settlement apparatus 100 to a higher-level apparatus, such as the money handling apparatus 300, the management apparatus 400, the headquarters system 20, and the like (STEP 116). When the above-explained operations are completed, the series of settlement processes ends.

According to the present embodiment, as explained in connection to STEP 110, the memory unit 152 stores therein the mutually associated tip amount identified by the tip amount identifying unit 158 and the tip recipient identified by the tip recipient identifying unit 160. Accordingly, the tip amount for respective clerks (respective persons in charge) can be managed. When distributing the tip to the respective clerks from the money settlement apparatus 100, the clerk places own ID card onto the code scanner 228 to allow the code scanner 228 to scan the ID card, read the ID information about the clerk from the ID card, and input the ID information to the register 200 as the information about the tip recipient. Then, the money equivalent to the tip amount linked with the inputted tip recipient information is dispensed by the banknote dispensing unit 116 and the coin dispensing unit 136 of the money settlement apparatus 100 based on the information stored in the memory unit 152.

According to the present embodiment, among the amount of the money handled in the settlement, the memory unit 152 stores therein the amount of the charge for the specific service including the charge for the food and drink that have been served to the customer (the service charge amount) and the tip therefor distinguishably from each other, and therefore, the money for the service charge amount only can be collected from the money settlement apparatus 100. More specifically, when collecting the money from the money settlement apparatus 100 and storing the collected money in the money handling apparatus 300, the money deposited to the money settlement apparatus 100 as the tip can be left inside the money settlement apparatus 100 and only the money deposited to the money settlement apparatus 100 as the charge for the specific service can be collected from the money settlement apparatus 100. As explained above, the memory unit 152 also stores therein the information about the change reserve money that is the amount of the banknotes and the coins to be dispensed from the money settlement apparatus 100 as the change. Accordingly, in the money settlement apparatus 100, the dispensing of the money as the change can be prioritized over the dispensing of the money as the tip. More specifically, if the money as the change reserve money stored inside the apparatus body of the money settlement apparatus 100 is insufficient, the payment of the tip from the money settlement apparatus 100 can be stopped.

The method of distributing the tips from the money settlement apparatus 100 to the clerks is not limited to the method in which the money equivalent to the tip amount linked to the tip recipient information is simply dispensed from the money settlement apparatus 100. In an alternative configuration, a method may be adopted in which plural pieces of ID information about plural clerks (plural persons in charge) are grouped and the memory unit 152 stores therein the mutually associated tip amount identified by the tip amount identifying unit 158 and information about the groups, for example. In this case, when the tips are distributed from the money settlement apparatus 100 to the clerks, the tip amount to be paid to the respective clerk is determined so that the tip amount paid to the persons in charge may be equal among each group. Various methods other than the methods explained above may be adopted to distribute the tips from the money settlement apparatus 100 to the respective clerks.

In the present embodiment, the method for the settlement process performed by the money handling system is not limited to the above-explained method. For example, if the customer has told the change amount to be returned to the customer, instead of telling the tip amount, when the customer pays the charge to the clerk, the clerk, after having received the money from the customer, inputs the information about the change amount to the register 200 instead of inputting the information about the tip. In this case, the information about the change amount is transmitted from the register 200 to the money settlement apparatus 100. The tip amount identifying unit 158 subtracts the total amount of the service charge amount and the change amount having been transmitted from the register 200 to the respective money settlement apparatuses 100 from the amount calculated by the amount calculating unit 156 (amount deposited to the money settlement apparatus 100) to identify the tip amount. The tip amount information identified by the tip amount identifying unit 158 is transmitted from the money settlement apparatus 100 to the register 200. Accordingly, the control unit 210 of the register 200 can also manage the tip amount information. In the money settlement apparatus 100, the money for the change amount transmitted from the register 200 is dispensed by the banknote dispensing unit 116 and the coin dispensing unit 136. The clerk returns the money dispensed as the change from the money settlement apparatus 100 to the customer.

If the customer has told a payment amount including the tip amount (that is, the “amount the customer want to pay” shown in FIG. 9) instead of telling the tip amount to the clerk when the customer pays the charge to the customer, the clerk, who has received the money from the customer, inputs the information about the money the customer wants to pay to the register 200 instead of inputting the tip information. In this case, the information about the money the customer wants to pay is transmitted from the register 200 to the money settlement apparatus 100. Because the “amount the customer want to pay” includes the tip amount, the “amount the customer want to pay” is naturally larger than the service charge amount acquired by the charge amount acquiring unit 250 of the register 200. The tip amount identifying unit 158 subtracts the service charge amount transmitted from the register 200 to the money settlement apparatus 100 from the “amount the customer want to pay” transmitted from the register 200 to the money settlement apparatus 100 to identify the tip amount. The tip amount information recognized by the tip amount identifying unit 158 is transmitted from the money settlement apparatus 100 to the register 200. Accordingly, the control unit 210 of the register 200 can manage even the tip amount information. The main control unit 150 of the money settlement apparatus 100 calculates the change amount by subtracting the “amount the customer want to pay” transmitted from the register 200 to the money settlement apparatus 100 from the amount calculated by the amount calculating unit 156 (amount deposited to the money settlement apparatus 100). Then, the main control unit 150 exerts control so that the money for the change amount is dispensed by the banknote dispensing unit 116 and the coin dispensing unit 136. The clerk returns the money dispensed as the change from the money settlement apparatus 100 to the customer.

If the clerk receives a credit card from the customer instead of cash, the clerk inputs the amount the customer wants to pay (for example, the amount the customer has written on the voucher) by operating the keyboard 220, the touch panel 234, and the like of the register 200, and then the clerk scans the credit card with the card reader 232. Accordingly, the information about the amount the customer wants to pay is inputted to the register 200 and the inputted information is transmitted from the register 200 to the money settlement apparatus 100. The tip amount identifying unit 158 subtracts the service charge amount transmitted from the register 200 to the money settlement apparatus 100 from the “amount the customer want to pay” transmitted from the register 200 to the money settlement apparatus 100 to identify the tip amount. When the customer performs the payment by the credit card, the customer may mention the tip amount by writing the tip amount, instead of the amount the customer wants to pay, on the voucher and the like. In this case, the clerk who has received the credit card inputs the service charge amount and the tip amount by operating the keyboard 220, the touch panel 234, and the like of the register 200, and then the clerk scans the credit card with the card reader 232. Accordingly, the amount of the information about the service charge amount and the tip amount is inputted to the register 200 and the inputted information is transmitted from the register 200 to the money settlement apparatus 100. The tip amount identifying unit 158 identifies the tip amount based on the information received from the register 200. If the customer makes the payment by the credit card, no money will be dispensed from the money settlement apparatus 100 as the change.

When the customer pays the charge to the clerk, the customer may pay an amount that is devoid of the tip, and in this case, the customer may pay the tip after receiving the change from the clerk. Operations of the money handling system performed in this case, in particular, operations of the money settlement apparatus 100 and the register 200 will be explained below with reference to the flowchart illustrated in FIG. 11.

When a customer sitting on a table of the restaurant shop 10 on the customer area 12 shows willingness to a clerk to settle the charge for the food and drink consumed by the customer, the clerk performs a voucher printing operation on the register 200 placed on the register counter. Before the clerk starts the voucher printing operation, a standby screen illustrated in FIG. 8(a) is displayed on the display unit for operator 224 of the register 200. When the clerk selects the item “1. PRINT VOUCHER” by operating the keyboard 220, the touch panel 234, or the like, names of the food dishes and drinks that were served to the customer can be inputted on the register 200. When the clerk inputs the names of the food dishes and drinks by operating the keyboard 220, the touch panel 234, or the like to calculate the service charge amount (STEP 201), a voucher showing the names of the food dishes and drinks and the total amount of the charge therefor is printed by the printer 230. In this process, the charge amount acquiring unit 250 of the register 200 acquires the total amount of the food and drink served to the customer (service charge amount) based on the information inputted by the clerk (STEP 202). The information about the service charge amount acquired by the charge amount acquiring unit 250 is transmitted from the register 200 to the money settlement apparatus 100 (STEP 203 and STEP 204). The clerk hands over the voucher printed by the printer 230 of the register 200 to the customer and requests the customer to pay the charge.

The customer who has received the voucher from the clerk pays the charge to the clerk. In the example illustrated in the flowchart of FIG. 11, the amount devoid of the tip is paid to the clerk. At this time, the customer may hand over a credit card to the clerk, instead of paying the charge in cash, and ask the clerk to process the payment by using the credit card.

Upon receiving the cash or the credit card from the customer, the clerk operates the money settlement apparatus 100 and the register 200 placed on the register counter to perform the settlement process. More specifically, the clerk first inputs, by operating the keyboard 220, the touch panel 234, and the like of the register 200, an instruction indicating that the tip will be deposited later. As a result, the tip amount identifying unit 158 identifies that the tip amount is initially “0”. Next, the clerk deposits the money received from the customer to the banknote settlement apparatus 110 and the coin settlement apparatus 130 of the money settlement apparatus 100 without performing any process thereto (STEP 205). The amount calculating unit 156 calculates, based on the results of the recognition of the banknotes and the coins by the recognition units 122 and 142, the amount of the money having been taken into the banknote settlement apparatus 110 and the coin settlement apparatus 130 (STEP 206).

The main control unit 150 of the money settlement apparatus 100 determines the change amount so that the total amount of the service charge amount transmitted from the register 200 and the amount of change of the banknotes and the coins to be dispensed as the change by the banknote dispensing unit 116 and the coin dispensing unit 136 is equal to the amount calculated by the amount calculating unit 156 (that is, the amount deposited to the money settlement apparatus 100). Then, the main control unit 150 exerts control so that the money for the change amount is dispensed by the banknote dispensing unit 116 and the coin dispensing unit 136 (STEP 207).

More specifically, in the exemplary case illustrated in the flowchart of FIG. 11, the amount handed over by the customer to the clerk after the customer has received the voucher from the clerk (that is, the amount deposited to the money settlement apparatus 100) includes the service charge amount that is the amount of charge for the food and drink themselves but does not include the tip amount, and the tip amount identifying unit 158 has identified that the tip amount is “0”. Accordingly, the change amount is calculated by subtracting the service charge amount from the amount handed over by the customer to the clerk. As explained above, the main control unit 150 determines the change amount by subtracting the service charge amount transmitted from the register 200 from the amount calculated by the amount calculating unit 156 (amount deposited to the money settlement apparatus 100) and exerts control so that the money equivalent to the change amount is dispensed from the banknote dispensing unit 116 and the coin dispensing unit 136. The clerk returns the money dispensed as the change from the money settlement apparatus 100 to the customer.

The information about the change amount calculated by the main control unit 150 is transmitted from the money settlement apparatus 100 to the register 200 (STEP 208 and STEP 209). Thus, the control unit 210 of the register 200 can manage even the change amount information.

Furthermore, in the example illustrated in the flowchart of FIG. 11, the customer pays the tip to the clerk after receiving the change from the clerk. The clerk deposits the money received from the customer as the tip to the banknote settlement apparatus 110 and the coin settlement apparatus 130 of the money settlement apparatus 100 without performing any process thereto (STEP 210). The tip amount identifying unit 158 identifies the amount of the money having been taken into the banknote settlement apparatus 110 and the coin settlement apparatus 130 as the tip amount based on the results of the recognition of the banknotes and the coins by the recognition units 122 and 142 (STEP 211). The tip amount information identified by the tip amount identifying unit 158 is transmitted from the money settlement apparatus 100 to the register 200 (STEP 212 and STEP 213). Thus, the control unit 210 of the register 200 can manage even the tip amount information.

When depositing the money received from the customer as the tip to the banknote settlement apparatus 110 and the coin settlement apparatus 130 of the money settlement apparatus 100, the clerk can input via the register 200 the tip recipient information about the clerk who is to receive the tip. To explain in more detail, the clerk scans own ID card with the code scanner 228 so that the ID information about the clerk is read by the code scanner 228, and then the read ID information is inputted to the register 200 as the information about the tip recipient. When the information about the tip recipient is inputted to the register 200, the information is transmitted from the register 200 to the money settlement apparatus 100. The tip recipient identifying unit 160 of the money settlement apparatus 100 identifies the tip recipient for the respective tips based on the information received from the register 200 (STEP 214). More specifically, the tip recipient identifying unit 160 identifies the ID information about the clerk read by the code scanner 228 of the register 200. When the tip amount is identified by the tip amount identifying unit 158 and the tip recipient for the respective tips is identified by the tip recipient identifying unit 160, the tip amount identified by the tip amount identifying unit 158 and the tip recipient identified by the tip recipient identifying unit 160 are associated with each other and the mutually associated pieces of information are stored in the memory unit 152 (STEP 215).

The series of settlement information explained above is transmitted by the communication unit 170 of the money settlement apparatus 100 to a higher-level apparatus such as the money handling apparatus 300, the management apparatus 400, the headquarters system 20, and the like (STEP 216). When the above-explained operations are completed, the series of settlement processes ends.

As explained above, according to the embodiment illustrated in the flowchart of FIG. 11, if the tip amount identified by the tip amount identifying unit 158 has been initially “0”, for one transaction, and if money has been taken in from the banknote inlet 114 and the coin inlet 134 after the money as the change has been dispensed by the banknote dispensing unit 116 and the coin dispensing unit 136 of the money settlement apparatus 100, the main control unit 150 of the money settlement apparatus 100 makes the memory unit 152 store the amount of the money that has been taken in as the tip amount.

The operations of the money settlement apparatus 100 and the register 200 are not limited to those illustrated in the flowcharts of FIGS. 10 and 11. Yet another method for handling money (specifically, a method for depositing a tip to the money settlement apparatus 100) will be explained below. In the present embodiment, the amount of money that has been taken into the money settlement apparatus 100 at an arbitrary timing can be stored in the memory unit 152 as the tip amount but not as the amount of money to be paid for a specific service of food, drink, and the like. More specifically, when the clerk selects the item “3. DEPOSIT TIP” by operating the keyboard 220, the touch panel 234, and the like via the standby screen illustrated in FIG. 8(a) displayed on the display unit for operator 224 of the register 200, the tip can be deposited to the money settlement apparatus 100. As explained above, a tip deposit mode is provided in addition to the normal settlement process mode as a money processing mode in the money handling system according to the present embodiment, and thereby the tip can be deposited to the money settlement apparatus 100 at an arbitrary timing regardless of the timing of the settlement process.

Operations of Money handling apparatus 300

Next, operations of the money handling apparatus 300 of the money handling system will be explained.

As explained above, the money handling apparatus 300 installed in the back office 14 performs a process of dispensing money as the change reserve money to be loaded to the money settlement apparatus 100, a process of depositing the money collected from the money settlement apparatus 100, and the like. The process of depositing the money in a case where the charge and the tip for the specific service is manually managed by the clerks by using drawers and pouches, without using the money settlement apparatus 100, can be performed. Operations performed for depositing money collected from the money settlement apparatus 100 or manually managed money to the money handling apparatus 300 will be explained below with reference to the flowchart illustrated in FIG. 12.

When depositing the money collected from the money settlement apparatus 100 or the manually managed money to the money handling apparatus 300, the clerk first selects a deposit mode as the process mode for the money handling apparatus 300 via the operation/display unit 380. Then, the clerk deposits the money collected from the money settlement apparatus 100 or the manually managed money to the banknote handling apparatus 310 and the coin handling apparatus 330 of the money handling apparatus 300 without performing any process thereto (STEP 301). The amount calculating unit 356 calculates the amount of money that has been taken into the banknote handling apparatus 310 and the coin handling apparatus 330 based on results of the recognition of the banknotes and the coins by the recognition units 322 and 342. Then, the operator inputs both or any one of the service charge amount and the tip amount via the operation/display unit 380. If only the service charge amount is inputted, the tip amount is calculated by subtracting the inputted service charge amount from the deposit amount calculated by the amount calculating unit 356. The tip amount identifying unit 358 identifies the tip amount based on the information inputted by the clerk (STEP 302).

When depositing the money collected from the money settlement apparatus 100 or the manually managed money to the banknote handling apparatus 310 and the coin handling apparatus 330 of the money handling apparatus 300, the clerk inputs the tip recipient information that is the information about the clerk who is to receive the tip to the money handling apparatus 300 (STEP 303). To explain in more detail, the clerk scans own ID card with a code scanner (not illustrated) so that the read ID information about the clerk is inputted to the money handling apparatus 300 as the information about the tip recipient.

The tip recipient identifying unit 360 of the money handling apparatus 300 identifies the tip recipient for the respective tips based on the inputted information (STEP 304). When the tip amount is identified by the tip amount identifying unit 358 and the tip recipient for the respective tips is identified by the tip recipient identifying unit 360, the tip amount identified by the tip amount identifying unit 358 and the tip recipient identified by the tip recipient identifying unit 360 are associated with each other and the mutually associated pieces of information are stored in the memory unit 352 (STEP 305).

The series of deposit information explained above is transmitted by the communication unit 370 of the money handling apparatus 300 to a higher-level apparatus such as the management apparatus 400, the headquarters system 20, and the like (STEP 306). When the above-explained operations are completed, the series of deposit processes ends.

According to the above-explained money handling apparatus 300, the memory unit 352 stores therein the mutually associated tip amount identified by the tip amount identifying unit 358 and the tip recipient identified by the tip recipient identifying unit 360. Accordingly, the tip amount for respective clerks (respective persons in charge) can be managed. In the present embodiment, the money as the tip can be dispensed from the money handling apparatus 300. When distributing the tip from the money handling apparatus 300 to the clerk, the clerk scans own ID card with the code scanner (not illustrated), the code scanner reads the ID information about the clerk from the ID card and inputs the ID information to the money handling apparatus 300. Then, the money equivalent to the tip amount linked with the inputted tip recipient information is dispensed from the banknote dispensing unit 316 and the drawer mounting unit 336 of the money handling apparatus 300 based on the information stored in the memory unit 352.

According to the present embodiment, the memory unit 352 stores therein the amount of the charge for the specific service including the charge for the food and drink that have been served to the customer and the tip therefor distinguishably from each other with respect to the amount of the deposited money, and therefore, the money corresponding to the charge paid for the specific service only can be collected from the money handling apparatus 300. More specifically, when collecting the money from the money handling apparatus 300, the money deposited to the money handling apparatus 300 as the tip can be left inside the money handling apparatus 300 and the money corresponding to the charge for the specific service only can be collected from the money handling apparatus 300. As explained above, the memory unit 352 also stores therein the information about the change reserve money that is the amount of the banknotes and the coins to be replenished into the money setting apparatus 100. With the above-explained configuration, the dispensing of the money from the money handling apparatus 300 as the change can be prioritized over the dispensing of the money as the tip. More specifically, if the money as the change reserve money stored inside the apparatus body of the money handling apparatus 300 is insufficient, the payment of the tip from the money handling apparatus 300 can be stopped.

The method of distributing the tips from the money handling apparatus 300 to the clerks is not limited to the method in which the money equivalent to the tip amount linked to the tip recipient information is simply dispensed from the money handling apparatus 300. In an alternative configuration, a method may be adopted in which plural pieces of ID information about plural clerks (plural persons in charge) are grouped and the memory unit 352 stores therein the mutually associated tip amount identified by the tip amount identifying unit 358 and information about the groups, for example. In this case, when the tips are distributed from the money handling apparatus 300 to the clerks, the tip amount to be paid to the respective clerk is determined so that the tip amount paid to the persons in charge may be equal among each group. Various methods other than the methods explained above may be adopted to distribute the tips from the money handling apparatus 300 to the respective clerks.

In the above-explained money handling system including the money settlement apparatus 100 and the register 200 of the present embodiment and the money handling method performed by this money handling system, the charge amount acquiring unit 250 that acquires the amount of the charge for the specific service, the amount calculating unit 156 that calculates the amount of money that has been taken in by the banknote inlet 114 and the coin inlet 134, and the tip amount identifying unit 158 that identifies the tip amount for the specific service are respectively provided. The main control unit 150 identifies the change amount so that the total of the amount of money acquired by the charge amount acquiring unit 250, the tip amount identified by the tip amount identifying unit 158, and the change amount of the money to be dispensed as the change by the banknote dispensing unit 116 and the coin dispensing unit 136 becomes equal to the amount calculated by the amount calculating unit 156, and exerts control so that the money for the change amount is dispensed by the banknote dispensing unit 116 and the coin dispensing unit 136. According to the money handling system and the money handling method, processes for depositing and dispensing banknotes and coins and the like can be mechanically and automatically performed while considering tips received from customers.

In the money handling apparatus 300 of the present embodiment and the money handling method performed by this money handling apparatus 300, the memory unit 352 stores therein the tip amount identified by the tip amount identifying unit 358 and the tip recipient identified by the tip recipient identifying unit 360 in a mutually associated manner. According to the money handling apparatus 300 and the money handling method explained above, the tip amount for the respective clerks (respective persons in charge) can be managed. When the tip is to be distributed from the money handling apparatus 300 to a clerk, money equivalent to the tip amount linked with the ID information about the clerk (information about the tip recipient) can be dispensed, for example. Even in the money settlement apparatus 100 according to the present embodiment and the money handling method performed by the money settlement apparatus 100, similar to the money handling apparatus 300 and the money handling method performed by the money handling apparatus 300, the memory unit 152 stores therein the tip amount identified by the tip amount identifying unit 158 and the tip recipient identified by the tip recipient identifying unit 160 in a mutually associated manner. With the above-explained configuration, the tip amount for the respective clerks (the respective persons in charge) can also be managed by the money settlement apparatus 100, and when distributing the tip from the money settlement apparatus 100 to a clerk, money equivalent to the tip amount linked with the ID information about the clerk (information about the tip recipient) can be dispensed, for example.

The configuration of the money handling system according to the present embodiment is not limited to the above-explained configuration and can be implemented by various modifications or alterations thereof.

In the money handling system explained with reference to FIGS. 1 to 7, the example is explained in which the money settlement apparatus 100 includes the memory unit 152, the amount calculating unit 156, the tip amount identifying unit 158, and the tip recipient identifying unit 160. However, the present invention is not limited to this configuration. In an alternative configuration, some or all of the memory unit 152, the amount calculating unit 156, the tip amount identifying unit 158, and the tip recipient identifying unit 160 can be arranged in the register 200 instead of arranging in the money settlement apparatus 100. In addition, charge amount acquiring unit 250 can be arranged in the money settlement apparatus 100 instead of arranging in the register 200. Moreover, in the money handling system explained with reference to FIGS. 1 to 7, the memory unit 352, the amount calculating unit 356, the tip amount identifying unit 358, the tip recipient identifying unit 360, and the operation/display unit 380 are arranged in the money handling apparatus 300. However, the present invention is not limited to this configuration. Some or all of the memory unit 352, the amount calculating unit 356, the tip amount identifying unit 358, the tip recipient identifying unit 360, and the operation/display unit 380 can be arranged in the management apparatus 400 instead of arranging in the money handling apparatus 300.

In an alternative configuration, instead of installing the register 200 at the register counter on the customer area 12 or in addition to installing the register 200 at the register counter, respective clerks may carry a personal digital assistant (not illustrated) such as an iPad (registered trademark) so that the service charge amount and the like can be notified to the customer by displaying the service charge amount and the like on the personal digital assistant for the settlement process, and tip information such as the tip amount can be inputted to the personal digital assistant. The personal digital assistant is communicably connected to the money settlement apparatus 100, and the like by wireless communication, for example. Therefore, information inputted to the personal digital assistant is transmitted to the money settlement apparatus 100 and various information is transmitted from the money settlement apparatus 100 to the personal digital assistant. If each clerk carries a personal digital assistant, the clerk can present the screen of the personal digital assistant to the customer so that the customer can directly input the tip information such as the tip amount by using the personal digital assistant. In yet another alternative configuration, some or all of the memory unit 152, the amount calculating unit 156, the tip amount identifying unit 158, and the tip recipient identifying unit 160 illustrated in FIG. 3 can be arranged in the above-explained personal digital assistant.

1. A money handling system that performs a process of settling a charge for a specific service, comprising:
a charge amount acquiring unit that acquires a charge amount corresponding to the charge;
an inlet unit for taking in money;
an amount calculating unit that calculates an amount of the money taken in by the inlet unit;
a money storage unit that stores therein the money of which the amount has been calculated by the amount calculating unit;
a change dispensing unit that dispenses money equivalent to a change amount as a change from the money storage unit or a change money storage unit;
a tip amount identifying unit that identifies a tip amount corresponding to a tip for the specific service; and
a control unit that determines the change amount so that a total of the charge amount acquired by the charge amount acquiring unit, the tip amount identified by the tip amount identifying unit, and the change amount of money to be dispensed as the change by the change dispensing unit becomes equal to the amount calculated by the amount calculating unit, and exerts control so that money equivalent to the change amount is dispensed by the change dispensing unit.

2. The money handling system according to claim 1, wherein the tip amount identifying unit identifies the tip amount based on a directly inputted tip amount.

3. The money handling system according to claim 1, wherein the tip amount identifying unit identifies the tip amount based on an inputted tipping ratio corresponding to the charge amount acquired by the charge amount acquiring unit.

4. The money handling system according to claim 1, wherein if a change amount to be dispensed as a change has been inputted, the tip amount identifying unit identifies the tip amount by subtracting a total amount of the charge amount acquired by the charge amount acquiring unit and the inputted change amount from the amount calculated by the amount calculating unit.

5. The money handling system according to claim 1, wherein if an amount of money to be paid larger than the charge amount acquired by the charge amount acquiring unit has been inputted, the tip amount identifying unit identifies the tip amount by subtracting the charge amount acquired by the charge amount acquiring unit from the inputted amount to be paid.

6. The money handling system according to claim 1, further comprising a communication unit that transmits the tip amount identified by the tip amount identifying unit to a higher-level apparatus.

7. The money handling system according to claim 1, further comprising:
a tip recipient identifying unit that identifies a tip recipient who is to receive the tip; and
a memory unit that stores therein the tip amount identified by the tip amount identifying unit and the tip recipient identified by the tip recipient identifying unit in a mutually associated manner.

8. The money handling system according to claim 7, wherein
the tip recipient identifying unit includes an ID information input unit that inputs ID information about a person in charge of a settlement process, and
the memory unit stores therein the tip amount identified by the tip amount identifying unit and the ID information inputted by the ID information input unit in a mutually associated manner.

9. The money handling system according to claim 1, further comprising a memory unit that stores therein information about the charge to be paid for the specific service and information about the tip therefor in a distinguishable manner with respect to an amount of money for which settlement a process is performed,
wherein the control unit, if the tip amount identified by the tip amount identifying unit has been initially “0”, in one transaction, and when money as a change has been taken in by the inlet unit after money as a change has been dispensed by the change dispensing unit, controls the memory unit to store therein the amount of the money that has been taken in as the tip amount.

10. The money handling system according to claim 9, wherein the tip amount identifying unit identifies that the tip amount has been initially “0” when an instruction that tip will be deposited afterwards has been inputted.

11. The money handling system according to claim 1, further comprising a memory unit that stores therein information about the charge to be paid for the specific service and information about the tip therefor in a distinguishable manner with respect to money for which a settlement process is performed,
wherein when the money has been taken in by the inlet unit, the amount of the money that has been taken in is selectively stored in the memory unit as the tip amount.

12. The money handling system according to claim 1, wherein the money handling system includes a money depositing and dispensing device and a register.

13. A money handling apparatus that performs a process of settling a charge for a specific service, comprising:
an inlet unit for taking in money;
an amount calculating unit that calculates an amount of the money taken in by the inlet unit;
a money storage unit that stores therein the money of which the amount has been calculated by the amount calculating unit;
a change dispensing unit that dispenses money equivalent to a change amount as a change from the money storage unit or a change money storage unit;
a tip amount identifying unit that identifies a tip amount corresponding to a tip for the specific service; and
a control unit that determines the change amount so that a total of an amount of the charge for the specific service, the tip amount identified by the tip amount identifying unit, and the change amount of money to be dispensed as the change by the change dispensing unit becomes equal to the amount calculated by the amount calculating unit, and exerts control so that money equivalent to the change amount is dispensed by the change dispensing unit.

14. The money handling apparatus according to claim 13, wherein the tip amount identifying unit acquires the tip amount based on tip amount information transmitted from an external apparatus.

15. A money handling method of performing a process of settling a charge for a specific service, the method comprising:
acquiring a charge amount corresponding to the charge;
taking in money;
calculating an amount of the money that has been taken in;
storing the money that has been taken in and of which the amount has been calculated;
dispensing money equivalent to a change amount as a change; and
identifying a tip amount for the specific service,
wherein the change amount is determined so that a total of an amount of charge for the specific service, the identified tip amount, and the change amount of money to be dispensed as the change becomes equal to the amount of the money that has been taken in, and money equivalent to the change amount is dispensed.

16. A money handling apparatus that performs a process of depositing money including a charge for a specific service and a tip therefor, comprising:
an inlet unit for taking in money;
an amount calculating unit that calculates an amount of the money taken in by the inlet unit;
a money storage unit that stores therein the money of which the amount has been calculated by the amount calculating unit;
a tip amount identifying unit that identifies a tip amount corresponding to the tip out of the money stored in the money storage unit;
a tip recipient identifying unit that identifies a tip recipient who is to receive the tip; and
a memory unit that stores therein the tip amount identified by the tip amount identifying unit and the tip recipient identified by the tip recipient identifying unit in a mutually associated manner.

17. The money handling apparatus according to claim 16,
wherein the tip recipient identifying unit includes an ID information input unit that inputs ID information about a person in charge of a deposit process, and
the memory unit stores therein the tip amount identified by the tip amount identifying unit and the 1D information inputted by the ID information input unit in a mutually associated manner.

18. The money handling apparatus according to claim 17, wherein
pieces of ID information about plural persons in charge are grouped, and
the memory unit stores therein the tip amount identified by the tip amount identifying unit and information about the group in a mutually associated manner.

19. The money handling apparatus according to claim 16, wherein the memory unit stores therein the charge paid for the specific service and the tip therefor in a distinguishable manner with respect to the amount of deposited money.

20. The money handling apparatus according to claim 19, wherein only money equivalent to the charge to be paid for the specific service is collected from the money handling apparatus.

21. The money handling apparatus according to claim 16, further comprising:
a dispensing unit that dispenses money stored as a tip,
wherein the dispensing unit, when a certain tip recipient performs an operation for dispensing money stored as a tip, dispenses money equivalent to the tip amount associated with the information only about the certain tip recipient.

22. A money handling method of performing a process of depositing money including a charge to be paid for a specific service and a tip therefor, the method comprising:
taking in money;
calculating an amount of the money that has been taken in;
storing the money that has been taken in and of which the amount has been calculated;
identifying a tip amount corresponding to the tip out of the stored money;
identifying a tip recipient who is to receive the tip; and
storing in a memory unit the identified tip amount and the identified tip recipient in a mutually associated manner.
